(19) United States
(12) Patent Application Publication
(10) Pub. No.: US 2011/0106629 A1
(43) Pub. Date: May 5, 2011

(54) SYSTEM AND METHOD FOR DISTRIBUTION OF CLASSIFIED ADVERTISEMENTS

(76) Inventors: Ole Bjorn Valen, Brevik (NO); Ole Aarrestad, Skien (NO)

(21) Appl. No.: 11/572,350

(22) PCT Filed: Jul. 19, 2005
(86) PCT No.: PCT/NO2005/000273

§ 371 Date: Apr. 9, 2009

(30) Foreign Application Priority Data
Jul. 19, 2004 (NO) 20043057

(51) Int. Cl. G06Q 30/00

(52) U.S. Cl. 705/14.69

(57) ABSTRACT

A system and method is disclosed for filing classified advertisements, which allows an automatized filing. The text of the advertisement is sent to a text message centre from the user's mobile phone, preferable as an SMS message. The text message centre transfers the text to a publication medium, for example a newspaper, for publication. Invoice information is sent to the telephone company for charging the customer's telephone bill.

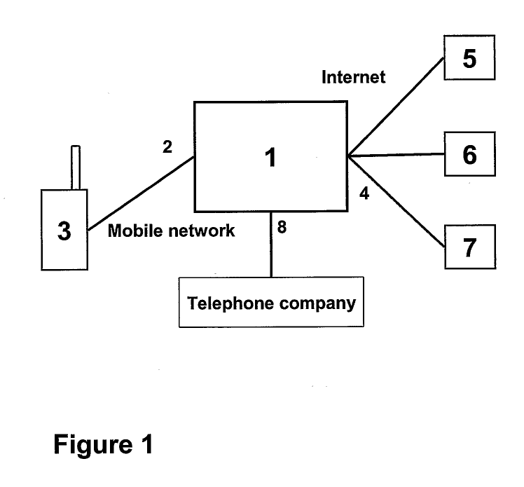

### FIELD OF THE INVENTION

The present invention relates to a system and method for distribution of classified advertisements to newspapers and magazines.

### TECHNICAL FIELD

Currently, classified advertisements are still mainly procured by direct delivery of the text over the counter, in the newspaper, or by mail. Another every so often used alternative is to procure the advertisement by telephone. This type of filing involves a large number of persons before the advertisement is published, for editing and writing the text in machine readable form, filling in the invoice, filing this in the accounting system, checking that the invoice is paid, etc. A more modern alternative is to procure the advertisement via the Internet, either by filling in a form on the newspaper's web page or by sending an email to the newspaper's editorial offices. Also, these methods have the drawback of demanding much manual work to finish the process. When the customer is using the Internet, the work with writing and editing the text itself becomes superfluous, but there is still some work to be done with registration and collection of payment for the advertisement.

### SUMMARY OF THE INVENTION

It is an object of the present invention to provide a system and a method for filing classified advertisements allowing a more automated and simplified filing involving less manual work on the receiving side, i.e. at the magazine or newspaper. This object is achieved with a system and method as stated in the appended claims. Briefly, the invention involves sending the advertisement's text to the newspaper from the customer's mobile phone, preferably as an SMS message, and charging the customer for the cost of the advertisement on the telephone bill.

The invention will now be described in detail in reference to the appended FIGURE, which shows a system for executing the invention.

### DETAILED DESCRIPTION OF THE INVENTION

The FIGURE shows a schematic overview of a system for implementation of the invention. The core of the system is a text message center in the form of a service server 1 operated by a service provider or telephone company. In the following, it is assumed that the text message center is operated by a service provider with an agreement with a telephone company. The service server 1 has a customer interface 2 to the mobile telephone network. The customer may access the server 1 from his/her mobile phone 3 via this interface for filing orders on classified advertisements. In addition, the server 1 has an Internet interface 4, which is used to send advertisement texts to the different newspapers represented by the servers 5, 6 and 7. Finally, the server 1 has an interface 8 to the telephone company. The system is used by the customer filing an order to the server 1. The order may be filled in on a WAP page, or by sending an MMS or SMS message to the server. Currently, the latter alternative is preferred, and will be described below. When the customer wants to file a classified advertisement, the person in question will send an SMS to the service provider, i.e. to the server 1. The SMS message may be sent to a number dedicated for this use. The service provider may serve several newspapers, and, for example, use dedicated SMS numbers for each newspaper. It is also possible that the newspaper does not want to dedicate a number for this purpose. In such cases, the SMS message may be started with a letter code, for example AN. The server 1 includes an application that analyzes the message. When the server detects a classified advertisement, the text itself is transferred to the newspaper's server, while invoice information is sent to the telephone company's accounting system. Then, the charged amount is automatically added to the user's telephone bill.

Alternatively, the amount may be charged to the user's bank account in accordance with authorization. However, this requires the establishment of a user profile for each user and the account information to be stored in the server 1. Such a system may also be used for charging a credit card or payment card. The server 1 may also be adapted to ask for credit/payment card information in a separate SMS, should it be impossible to charge the telephone bill or if there is registered no authorization for charging an account belonging to the user.

The solution does not require the installation of any separate application on the mobile terminal, but requires that the message be correctly formatted, for example, including a preamble according to the letter combination mentioned above.

It is stressed that the invention is applicable in all publication mediums, i.e., also in modern forms of electronic publishing, in addition to paper based mediums.

1. A system for distribution of classified advertisements comprising:
a service server with a first interface to a public mobile network, the service server being adapted to receive a classified advertisement sent from a mobile terminal belonging to a user of the system,
a second interface for communication with a second server belonging to a publication medium, the service server being adapted to send the classified advertisement to the second server on the purpose of publicizing the advertisement in the publication medium, and
a third interface for communication with a payment service.

2. A system as claimed in claim 1 wherein the service server is adapted to receive the classified advertisement from the mobile terminal as an SMS or MMS message.

3. A system as claimed in claim wherein first interface is a WAP interface, the service server (1) being adapted to receive the classified advertisement as a text filled in on a WAP page.

4. A system as claimed in claim 1 wherein the payment service has means for handling by a telephone operator, the service server being adapted to send invoice information to said telephone operator for charging the classified advertisement directly on the user's telephone bill.

5. A system as claimed in claim 1 wherein the payment service has means for handling by a credit card or payment card company, the service server being adapted to send invoice information to said company in order to charge the classified advertisement directly on the user's account.

6. A system as claimed in claim 5 wherein the service server has means for sending a message to the user's mobile terminal in order to retrieve payment information for the user.

7. A system as claimed in claim 1 wherein the service server is included in a text message centre.

8. A method for mediation of classified advertisements comprising:
sending a message with the text of a classified advertisement from a user's mobile terminal belonging to a service server,
sending the text from the service server to a server belonging to a publication medium for publication in said medium, and
sending invoice information from the 'service server to a payment service.

9. A method as claimed in claim 8 further comprising the payment service being handled by a telephone operator, the telephone operator charging the classified advertisement directly on the user telephone bill.

10. A method as claimed in claim 8 further comprising the payment service being handled by a credit card or payment card company, said company charging the classified advertisement directly from the user's account.
